(19) United States
(12) Patent Application Publication
(10) Pub. No.: US 2020/0210569 A1
(43) Pub. Date: Jul. 2, 2020

(54) PROTECTION CIRCUIT

(71) Applicants: STMicroelectronics (Rousset) SAS, Rousset (FR); STMicroelectronics (Alps) SAS, Grenoble (FR)

(72) Inventors: Diana Moisuc, Saint Egreve (FR); Christophe Laurencin, Peypin (FR)

(21) Appl. No.: 16/728,946

(22) Filed: Dec. 27, 2019

(30) Foreign Application Priority Data
Dec. 28, 2018 (FR) 1874287

(51) Int. Cl. G06F 21/55; H01L 23/00; H02H 1/00

(52) U.S. Cl. CPC G06F 21/554; G06F 2221/034; H02H 1/0007; H01L 23/576

(57) ABSTRACT

In an embodiment, an electronic circuit includes a plurality of protective nodes. Each protective node includes at least one monitoring circuit for processing information representative of a detection of a disturbance based on a detection circuit; and at least one reaction circuit for implementing a countermeasure controlled by the monitoring circuit.

### CROSS-REFERENCE TO RELATED APPLICATIONS

This application claims priority to French Patent Application No. 1874287, filed on Dec. 28, 2018, which application is hereby incorporated herein by reference.

### TECHNICAL FIELD

The present disclosure relates generally to circuits and electronic systems and, more particularly, to a protection circuit.

### BACKGROUND

Certain electronic circuits manipulate data or execute algorithms or programs for which it is desired to reserve access to authorized users or circuits. One generally refers in such cases to secret data or encryption algorithms using so-called secret keys.

In order to unlock the secrets of such circuits and, for example, discover the secret quantities or data handled, a category of attacks injects permanent or temporary faults into the circuit in order to be able to analyse its reaction. These analyses are, for example, analyses by hidden channels that analyse the power consumption of the circuit (analysis of the power consumption of SPA—Simple Power Analysis—type or of DPA—Differential Power Analysis—type), its electromagnetic radiation, etc. These analyses can also be analyses of the response of the circuit (of its inputs-outputs), etc.

The injection of faults is carried out more and more often without using the inputs and outputs of the circuit but by modification of internal states, for example by using a laser (FIB—Focused Ion Beam—attacks), by electrical or electromagnetic disturbance, or in a more intrusive manner by forcing certain internal states by physically cutting off or diverting electrical paths. Some of these attacks call for preliminary treatments for the elimination of layers (backside attacks) or the realization of windows in order to access the active layers.

In electronic circuits, for example so-called secure microcontrollers, the circuit is equipped with mechanisms for countering potential attacks or, at the very least, limiting their effects. In particular, the countermeasures aim to prevent the attacker from managing to extract secret data or quantities from the protected circuit.

### SUMMARY

Some embodiments relate to a countermeasure against attacks by fault injection in an electronic circuit. In some embodiments, a countermeasure includes blocking writing into a memory, blocking access into a memory, deleting some or all content of a memory, and deleting a cryptographic key of an encryption circuit, for example.

Some embodiments apply more specifically to a category of countermeasures that reset the circuit when an attempted attack is detected. Such a reset prevents the attacker from being able to extract sensitive information. However, a difficulty is that by carrying out the attack several times in a localized manner, the attacker is likely to identify the zone of the microcontroller where the circuits that trigger the reset and/or the conductors that convey the reset signals can be found. Once this identification occurs, the attacker may be able to thwart the reset and the microcontroller may no longer be secure.

One embodiment provides a circuit for protecting against attacks by fault injection that addresses all or some of the drawbacks of known solutions.

One embodiment provides an electronic circuit comprising:
a plurality of protective nodes, each comprising:
at least one processing function for processing information representative of a detection of a disturbance, deriving from at least one detection function; and
at least one function for implementing a countermeasure controlled by the processing function.

According to an embodiment, each node comprises at least one function for detecting a disturbance.

According to an embodiment, each processing function receives information from all the detectors of the circuit.

According to an embodiment, the processing functions of the different nodes communicate between one another.

According to an embodiment, the processing functions are linked between one another via a bus.

According to an embodiment, the processing functions are linked in pairs via dedicated links.

One embodiment provides a microcontroller comprising a circuit as described.

According to an embodiment, the microcontroller further comprises a circuit for controlling a reset of the microcontroller.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 illustrates an example electronic circuit of the type to which the described embodiments apply;

FIG. 2 illustrates, very schematically and in the form of a time chart, an example of a conventional electromagnetic signature of a secure microcontroller during the detection of a potential attack;

FIG. 3 illustrates, very schematically and in the form of blocks, an embodiment of an electronic circuit equipped with an embodiment of a protective architecture;

FIG. 4 illustrates, very schematically and in the form of blocks, an embodiment of a protective node;

FIG. 5 illustrates, very schematically and in the form of blocks, an example architecture for securing a microcontroller; and

FIG. 6 illustrates, very schematically and in the form of blocks, a further example architecture for securing a microcontroller.

### DETAILED DESCRIPTION OF ILLUSTRATIVE EMBODIMENTS

Like features have been designated by like references in the various figures. In particular, the structural and/or functional features that are common among the various embodiments may have the same references and may have identical structural, dimensional and material properties.

For the sake of clarity, only the operations and elements that are useful for an understanding of the described embodiments herein have been illustrated and described in detail. In particular, the applications and the functions implemented by the protected electronic circuit have not been described in detail, the described protective mechanisms being compatible with applications and functions of conventional circuits. Furthermore, detectors of intrusions or attacks have not been described in detail, the described embodiments relating to countermeasures and being compatible with any conventional detector.

Unless indicated otherwise, when reference is made to two elements that are connected together, this means a direct connection without any intermediate elements other than conductors, and when reference is made to two elements that are linked or coupled together, this means that these two elements can be connected or be linked or coupled by way of one or more other elements.

In the following disclosure, unless indicated otherwise, when reference is made to absolute positional qualifiers, such as the terms “front,” “back,” “top,” “bottom,” “left,” “right,” etc., or to relative positional qualifiers, such as the terms “above,” “below,” “higher,” “lower,” etc., or to qualifiers of orientation, such as “horizontal,” “vertical,” etc., reference is made to the orientation shown in the figures.

Unless specified otherwise, the expressions “around,” “approximately,” “substantially,” and “in the order of,” signify within 10%, and preferably within 5%.

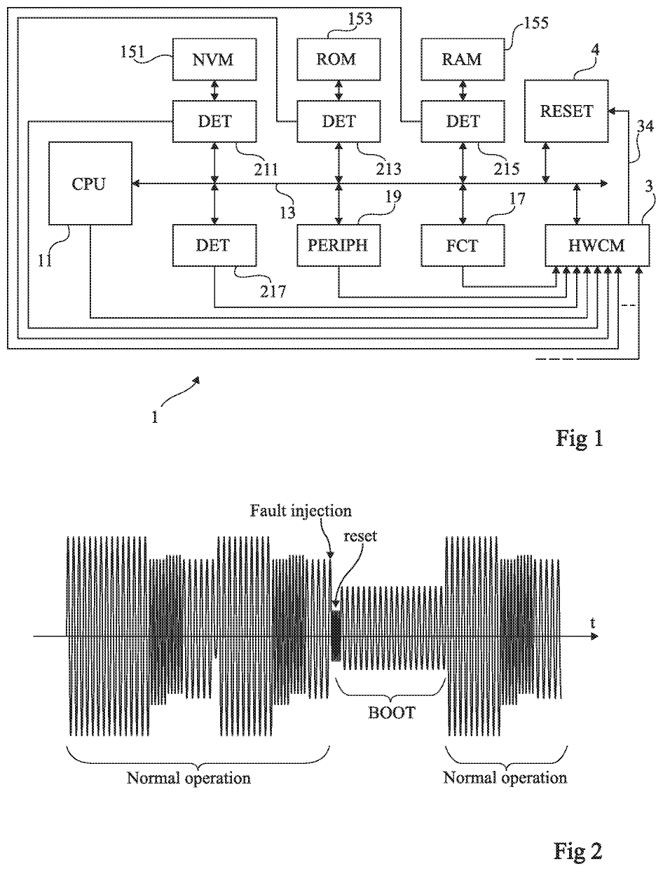

FIG. 1 illustrates an example of an electronic circuit of the type to which the described embodiments apply.

The circuit of FIG. 1 is, for example, a secure microcontroller 1.

Such a microcontroller is based on a microprocessor or central processing unit 11 (CPU), capable of communicating, via one or more buses 13, with various other circuits with which it is integrated.

Typically, the microcontroller 1 integrates memory circuits, for example one or more rewritable non-volatile memories 151 (NVM), one or more read-only memories 153 (ROM), one or more volatile memories 155 (RAM). The microcontroller can also integrate various hardware functions or circuits, represented by a block 17 (FCT), for example a cryptographic function, specific calculation functions, wired and/or wireless input/output interfaces, etc.

Depending on the application, the microcontroller 1 also communicates, via the one or more buses 13, with one or more internal or external peripheral devices, represented by a block 19 (PERIPH), for example, detectors of ambient characteristics (pressure, temperature, etc.) or others.

In a secure microcontroller application, the secure microcontroller aims to ensure that it is always in a secure state, in which secrets contained in the system are not divulged. For this purpose, the circuit or microcontroller 1 includes various hardware and/or software detectors (DET) that aim to detect attempts to attack the content of the microcontroller 1 or to detect a random or voluntary malfunction. Such detectors may take various forms. For example, the detectors may be hardware detectors capable of detecting an electrical or electromagnetic disturbance after the circuit has been subjected to a structural modification such as the elimination of layers present at the backside. The detectors may also be hardware detectors of laser attacks. The detectors may also be software detectors capable of detecting an operational malfunction of certain functions of the circuit. The detectors may or may not be associated with specific functions of the microcontroller. As shown in FIG. 1, microcontroller 1 includes detectors 211, 213 and 215 inserted between memories 151, 153, 155 and the bus 13. Detectors 211, 213 and 215 are thus dedicated to the corresponding memory. Microcontroller 1 also includes detector 217, which is independent of a particular function. Furthermore, the functions 17 and/or the peripheral devices 19 of the circuit 1 may also be associated with detectors (not shown).

All disturbance detectors with the object of detecting a fault potentiality are electrically linked (in a wired manner) to a hardware and/or software unit 3 (HWCM), such as a control circuit, for reacting or for implementing a countermeasure to the suspected attack. The role of the unit 3 is to act on a plurality of functions of the circuit 1 as well as to trigger a resetting of the circuit 1. In FIG. 1, a reset circuit 4 (RESET) separate from the other circuits and functions is represented.

Reset circuit 4 is configured to keep circuit 1 remains in a secure state, e.g., in the presence of an alarm indicating a malfunction, wherein the malfunction may be accidental or voluntary (attack). For example, in some embodiments, reset circuit 4 prevents sensitive zones of the circuit 1 from becoming accessible as the result of an attack by restarting all functions restart to their original secure state upon detection of a malfunction.

However, the reaction of the circuit 1 that is manifested by a reset is an indication that is observable by the attacker, revealing to the attacker that the attack has modified the behavior of the circuit.

In particular, any reaction of the circuit, for example a power consumption signature, radiation signature, etc. which is different from that which occurs during normal operation provides the attacker with information. If an attacker identifies a reaction of the circuit, this signals the attacker that the attack has caused an atypical behavior of the circuit. The attacker can thus carry out a further attack that inhibits the reaction of the circuit. For example, by identifying the zone of the circuit that triggers the reset, the attacker can intervene so as to prevent its operation. It is then sufficient for the attacker to re-execute the first attack, as the circuit is no longer in a safe or secure state. The reset of a microcontroller is, furthermore, particularly identifiable from a power consumption or electromagnetic signature.

More specifically, if the attacker succeeds in locating the physical conductor 34 linking the circuit 3 to the reset entity 4, it is sufficient for the attacker to cut off or divert this conductor in order to be able to re-execute the first attack and that this attack is successful.

FIG. 2 illustrates, very schematically and in the form of a time chart, an example of a conventional electromagnetic signature of a secure microcontroller during the detection of a potential attack.

An initial normal operation (Normal operation) of the microcontroller is assumed.

During a fault injection (Fault injection), or more generally an action or operation detected as abnormal by one of the detectors DET (FIG. 1), the circuit 3 normally immediately triggers a reset (RESET) of the microcontroller. The microcontroller is thus restarted (BOOT). Then the microcontroller resumes its normal operation (Normal operation). The restart BOOT of the microcontroller is generally easy to identify because it is generally of a fixed duration.

According to some embodiments, a new organization of the countermeasures is provided within the electronic circuit. In other words, the integration of a particular protective architecture in the electronic circuit to be protected is provided.

According to an embodiment, at least two protective circuits, or protective nodes, each equipped with one or more disturbance detectors is provided. Each protective circuit or node comprises a circuit for interpreting the detection and for communicating with the other nodes. Each protective node is further associated with one or more reactive functions or countermeasures that are dedicated to the same. Thus, each protective node is capable of implementing, simultaneously, a so-called local reaction for securing a specific function of the protected electronic circuit (e.g., each local reaction is different), and a communication with one or more other protective circuits. This communication is carried out either via the general bus 13 of the microcontroller, or via a specific bus, or via conductors linking the different protective nodes in pairs in a mesh network. By informing the other protective circuits of a malfunction related to an attempted attack, it is possible for these other circuits to themselves implement the local reaction for securing the specific function with which they are respectively associated.

Thus, the reaction or countermeasure of each protective circuit can be triggered as the result of a detection at the level of the protective node in question or as the result of a detection by any of the protective nodes.

The local reaction or countermeasure can take various forms, in themselves conventional, according to the function with which the protective circuit is associated. These are, for example, a blocking of writing or of accesses in a memory, a deletion of the volatile memory, a blocking of the outputs of an input-output interface, a deletion of cryptographic keys of an encryption circuit, etc.

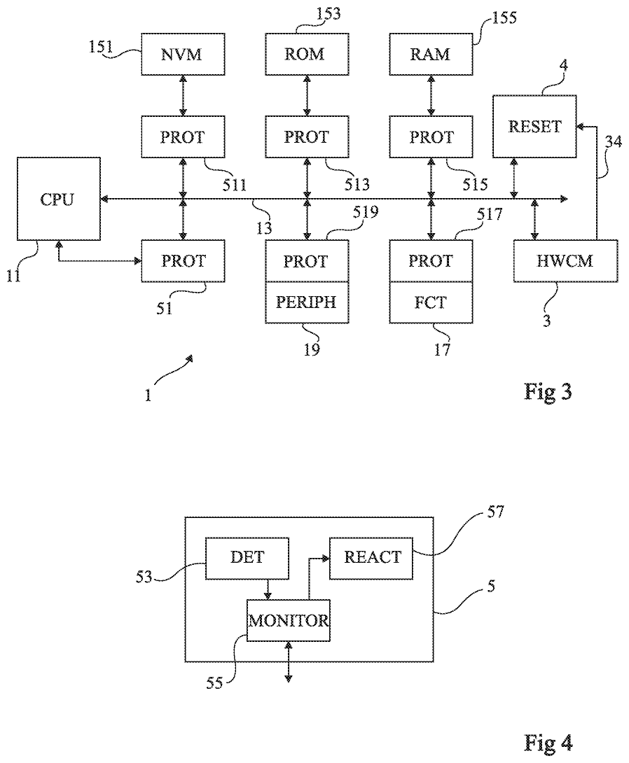

FIG. 3 illustrates, very schematically and in the form of blocks, an embodiment of an electronic circuit equipped with an embodiment of a protective architecture.

The circuit of FIG. 3 is, for example, a secure microcontroller 1.

As in the foregoing, such a microcontroller is based on a microprocessor or central processing unit 11 (CPU), which is able to communicate via one or more buses 13 with various other circuits with which it is integrated. For the sake of simplification, one bus 13 has been illustrated in FIG. 3, but most often a plurality of buses—respectively address, data and command buses—would be present. Moreover, some components of the microcontroller can also communicate directly between one another.

Typically, the microcontroller 1 integrates memory circuits, for example one or more rewritable non-volatile memories 151 (NVM), one or more read-only memories 153 (ROM), one or more volatile memories 155 (RAM). The microcontroller can also integrate various hardware functions or circuits, represented by a block 17 (FCT), for example a cryptographic function, specific calculation functions, wired and/or wireless input/output interfaces, etc.

Depending on the application, the microcontroller 1 also communicates, via the one or more buses 13, with one or more internal or external peripheral devices, represented by a block 19 (PERIPH), for example detectors of ambient characteristics (pressure, temperature, etc.) or others.

The microcontroller of FIG. 3 is further equipped with a particular protective architecture.

In the example illustrated in FIG. 3, the memories 151, 153, 155 are each associated with a protective circuit or node, respectively 511, 513 and 515. Furthermore, it is assumed that the functions 17 and the peripheral devices 19 are also associated with protective nodes 517 and 519 and that the circuit further integrates at least one protective node 51 interacting with the central processing unit 11 (for example, in order to reset its clock).

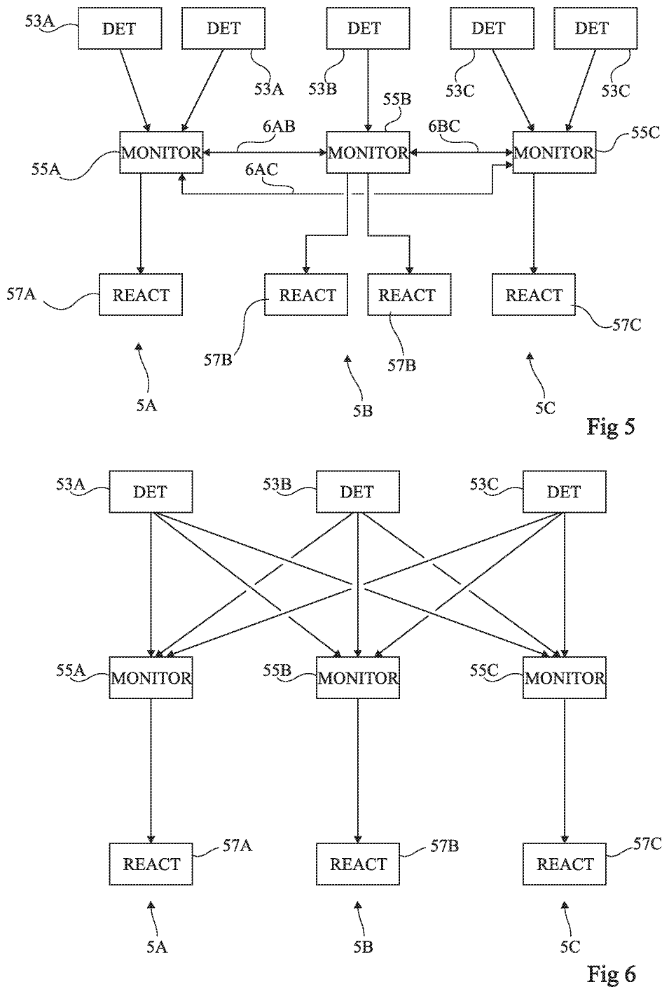

In the example of FIG. 3, it is assumed that the protective nodes communicate between one another via the bus 13; however, further examples will be illustrated in relation to FIGS. 5 and 6.

FIG. 4 illustrates, very schematically and in the form of blocks, an embodiment of a protective node 5, of the same type as the nodes 511, 513, 515, 517, 519 and 51 shown in FIG. 3.

Each protective node 5 comprises or is associated with at least one hardware and/or software detector 53 (DET) for detecting an accidental or voluntary malfunction. Some embodiments may use conventional detectors. Some embodiments use conventional methods or ways of detecting a potential attack or disturbance based on detection mechanisms such as photonic, electric, magnetic, etc.; local or distributed in the circuit, hardware or software, etc.

Each protective node 5 comprises or is associated with a processing or monitoring circuit (or function) 55 (MONITOR) which receives information representative of a malfunction detected at the microcontroller. For example, each circuit 55 receives and processes the signals from the at least one detector 53 of the node with which it is associated. The role of the circuit 55 is, in the event of a detected malfunction, to trigger a local reaction (block 57, REACT) associated with the node in question and, e.g., preferably, to inform the other nodes (their monitoring circuits) of the attempted attack in order for the other nodes to also implement their respective local countermeasures. Each circuit 55 is thus further capable of receiving information from other circuits 55 in order to trigger an action of its own reactive circuit 57.

As shown in FIG. 5, each node 5 of the system is configured to detect local malfunctions (e.g., via detector circuit 53), receive information from other nodes about malfunctions detected by such other nodes, and implement local reactions (e.g., a reaction local to each respective node 5) based on locally detected malfunctions or information about a malfunction received from another node. Therefore, if one node detects a malfunction, all nodes receiving malfunction information from such one node react locally to such malfunction.

In some embodiments, therefore, a distributed reaction to an attack may be achieved, which may advantageously make a system, such as a secure microcontroller, more resistance to multiple physical attacks.

It should be noted that the implementation of the provided architecture is compatible with the implementation of a global protection as illustrated in FIG. 1. Thus, the microcontroller 1 of FIG. 3 also includes a hardware and/or software unit 3 (HWCM), which receives information from all detectors 53 (all nodes 5). The unit 3 is capable of triggering, via a reset circuit 4 (RESET), a resetting of the circuit 1. In FIG. 3, a reset circuit 4 (RESET) separate from the other circuits and functions is represented. The reset function may, as a variant, be at the central processing unit 11. The communication between the various nodes 55 and the unit 3 can pass through dedicated wired links or via the bus 13.

An advantage of the described architecture is that, even if an attacker manages to locate the electrical link 34 between the unit 3 and the reset circuit 4 and to interrupt this link, the microcontroller remains secure. Indeed, this will prevent a global reset of the microcontroller by this unit 3 at the next attack, but will not prevent the implementation of the other security countermeasures associated with the various nodes. The described embodiments are further compatible with any conventional countermeasure.

In cases where the bus 13, or a specific bus shared by the different nodes, is used to have their respective circuits 55 communicate, periodic communication cycles can be provided which make it possible for the nodes to detect a potential breach of the bus and thus to implement their respective countermeasures. In practice, in a communication cycle, each node successively takes the bus in order to transmit its state to all the other nodes.

As a variant, the value to be conveyed on the bus in order to indicate an absence of a disturbance is programmable and the program may be configured to refresh such value periodically, wherein the nodes interpret the failure to update such value as an error.

FIG. 5 illustrates, very schematically and in the form of blocks, an example architecture for securing a microcontroller in accordance with the principles illustrated in FIGS. 3 and 4.

For the sake of simplification, only the protective nodes and their links have been illustrated. The interactions between the countermeasure circuit of each node and the function of the microcontroller with which it is associated have not been illustrated.

In the example shown in FIG. 5, it is assumed that the protective architecture comprises three nodes 5A, 5B and 5C, the respective monitoring circuits 55A, 55B and 55C of which receive signals from detectors 53A, 53B and 53C and command local reactions 57A, 57B and 57C. According to the embodiment shown in FIG. 5, each monitoring circuit 55 communicates with the monitoring circuits of the other nodes via dedicated links 6AB, 6BC and 6AC, in pairs.

The example shown in FIG. 5 also illustrates the case of nodes having a plurality of detectors (the nodes 5A and 5C each have two detectors, respectively 53A and 53C) and having a plurality of reactive units (the node 5B has two countermeasure circuits 57B).

FIG. 6 illustrates, very schematically and in the form of blocks, an example architecture for securing a microcontroller in accordance with the principles illustrated in FIGS. 3 and 4.

As in the example shown in FIG. 5, the case is assumed in which three nodes 5A, 5B and 5C each include a respective detector 53A, 53B, 53C, a respective monitoring circuit 55A, 55B, 55C, and a respective reactive circuit 57A, 57B, 57C.

However, in the embodiment shown in FIG. 6, the monitoring circuits 55 do not communicate between one another but each receives the detection result from the different detectors 53 of the microcontroller. Each circuit 55 acts on the reactive circuit of its node.

Thus, in this embodiment, all detection results are sent to all protective nodes (and their respective monitoring circuits).

An advantage of the described embodiments is that the reaction of the protected circuit is more difficult to detect by an attacker.

A further advantage is that the placing of the circuit in a state of protection (as a result of the detection of an attack) engenders local reactions the control of which is not centralized. It is thus much more difficult for an attacker to counter the reaction of the circuit. In particular, the attacker may need to detect and physically sever all electrical links of the protective architecture in order to be able to re-execute his attack without the circuit placing itself in a secure state.

It should be noted that the elements (detector(s) 53, monitoring circuit 55, and reactive function(s) 57) of a same node 5 can be spread out in the integrated circuit. In other words, the detector(s) 53, monitoring circuit 55, and reactive function(s) 57) of a same node 5 are not necessarily physically adjacent to one another. For example, in some embodiments, a detector 53 of a given node 5 may be near one corner of a monolithic substrate of an integrated circuit, the monitoring circuit 55 may be near another corner of the monolithic substrate, and a reactive function 53 may be near yet another corner of the monolithic substrate. Other implementations are also possible.

Although a software implementation of the surveillance functions 55 at certain nodes 5 is not excluded, the monitoring circuits 55 are preferably implemented in hardware. The detection functions 53 and the countermeasures 57 can for their part take the form of software and/or hardware depending on the nodes.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove, in particular as far as the choice of reactions (countermeasures) executed by the microcontroller as a result of the detection of an attack is concerned.

What is claimed is:

1. An electronic circuit comprising:
a plurality of protective nodes, each protective node of the plurality of protective nodes comprising:
a respective monitoring circuit configured to process information representative of a detection of a disturbance generated by a detection circuit; and
a respective reaction circuit configured to perform a countermeasure controlled by the respective monitoring circuit.

2. The electronic circuit of claim 1, wherein each protective node comprises the detection circuit coupled to the respective monitoring circuit, wherein the detection circuit is configured to detect a disturbance.

3. The electronic circuit of claim 2, wherein each monitoring circuit of the electronic circuit is configured to receive information from all detection circuits of the electronic circuit.

4. The electronic circuit according to claim 1, wherein each monitoring circuit of the electronic circuit is configured to communicate to each other of the monitoring circuits of the electronic circuit.

5. The electronic circuit according to claim 4, wherein each monitoring circuit of the electronic circuit is coupled to a bus, and wherein each monitoring circuit of the electronic circuit is configured to communicate to each other of the monitoring circuits of the electronic circuit via the bus.

6. The electronic circuit according to claim 4, wherein each monitoring circuit of the electronic circuit is coupled to each other of the monitoring circuits of the electronic circuit via respective dedicated links, and wherein each monitoring circuit of the electronic circuit is configured to communicate to each other of the monitoring circuits of the electronic circuit via the respective dedicated links.

7. The electronic circuit of claim 1, wherein a protective node of the plurality of protective nodes comprises a plurality of detection circuits coupled to the respective monitoring circuit, each detection circuit of the plurality of detection circuits configured to detect disturbances.

8. The electronic circuit of claim 1, wherein a protective node of the plurality of protective nodes comprises a plurality of reaction circuits coupled to the respective monitoring circuit, each reaction circuit of the plurality of reaction circuits configured to perform countermeasures controlled by the respective monitoring circuit.

9. The electronic circuit of claim 1, wherein the electronic circuit is a microcontroller.

10. The electronic circuit of claim 1, further comprising a reset circuit configured to reset the electronic circuit based on a reaction circuit of a protective node of the plurality of protective nodes.

11. A method comprising:
detecting a disturbance in an electronic circuit with a first detection circuit of a first protective node of a plurality of protective nodes of the electronic circuit;
processing information representative of the detected disturbance with a first monitoring circuit of the first protective node; and
performing a first countermeasure with a first reaction circuit of the first protective node based on an output of the first monitoring circuit.

12. The method of claim 11, further comprising:
receiving, by a second monitoring circuit of a second protective node of the plurality of protective nodes, information representative of the detected disturbance from the first monitoring circuit; and
performing a second countermeasure with a second reaction circuit of the second protective node based on an output of the second monitoring circuit.

13. The method of claim 12, wherein the first countermeasure is different from the second countermeasure.

14. The method of claim 12, wherein the first protective node is associated with a first circuit, wherein the second protective node is associated with a second circuit, wherein the first countermeasure comprises modifying an aspect of the first circuit, and wherein the second countermeasure comprises modifying an aspect of the second circuit.

15. The method of claim 14, wherein the first circuit is a memory, and wherein modifying an aspect of the first circuit comprises blocking writing into the memory, blocking access into the memory, deleting content of the memory.

16. The method of claim 12, further comprising transmitting the information representative of the detected disturbance from the first monitoring circuit to the second monitoring circuit via a bus that is coupled to all protective nodes of the plurality of protective nodes.

17. The method of claim 12, further comprising transmitting the information representative of the detected disturbance from the first monitoring circuit to the second monitoring circuit via a dedicated link that is coupled between the first monitoring circuit and the second monitoring circuit.

18. The method of claim 11, wherein the disturbance is caused by an attack.

19. The method of claim 18, wherein the attack comprises a focused ion beam (FIB) attack, or physically cutting off or diverting an electrical path of the electronic circuit.

20. A microcontroller comprising:
a first protective node comprising:
a first detection circuit configured to detect a disturbance of the microcontroller,
a first monitoring circuit configured to process information representative of the detected disturbance, and
a reaction circuit configured to perform a first countermeasure based on an output of the first monitoring circuit; and
a second protective node comprising:
a second monitoring circuit configured receive information representative of the detected disturbance from the first monitoring circuit, and
a second reaction circuit configured to perform a second countermeasure based on an output of the second monitoring circuit.

21. The microcontroller of claim 20, further comprising:
a first circuit associated with the first protective node; and
a second circuit associated with the second protective node, wherein the first countermeasure comprises modifying an aspect of the first circuit, and wherein the second countermeasure comprises modifying an aspect of the second circuit.
